(19) United States
(12) Patent Application Publication
(10) Pub. No.: US 2026/0085646 A1
(43) Pub. Date: Mar. 26, 2026

(54) ENGINE CONTROL SYSTEM

(71) Applicant: SUBARU CORPORATION, Tokyo (JP)

(72) Inventors: Yuki KANEMOTO, Tokyo (JP); Izumi HONDA, Tokyo (JP)

(73) Assignee: SUBARU CORPORATION, Tokyo (JP)

(21) Appl. No.: 19/308,558

(22) Filed: Aug. 25, 2025

(30) Foreign Application Priority Data
Sep. 25, 2024 (JP) 2024-166813

(51) Int. Cl. F02D 41/06

(52) U.S. Cl. CPC F02D 41/061; F02D 2200/503

(57) ABSTRACT

An engine control system includes a communication terminal, a wireless communicator, an engine, a battery, a first detector that is configured to detect a remaining charge of the battery, and one or more controller processors. The one or more controller processors are configured to execute, when the wireless communicator receives startup information from the communication terminal, starting up the engine and operating the engine over a running time that is set in advance, determining whether a predetermined condition related to the battery is met based on at least the remaining charge of the battery, stopping the engine based on the running time that is set in advance elapsing when the predetermined condition is met, and performing an extension of running time of the engine from the running time that is set in advance when the predetermined condition is not met.

### CROSS-REFERENCE TO RELATED APPLICATIONS

The present application claims priority from Japanese Patent Application No. 2024-166813 filed on Sep. 25, 2024, the entire contents of which are hereby incorporated by reference.

### BACKGROUND

The disclosure relates to an engine control system.

Japanese Unexamined Patent Application Publication (JP-A) No. 11-62793 discloses a communication device that is capable of transmitting a signal to a vehicle, for startup an engine of the vehicle. Also disclosed is that based on receipt of a signal from a transmitter, the engine is started up and the engine is caused to run over a period of time that is set in advance.

### SUMMARY

An engine control system according to an embodiment of the disclosure includes a communication terminal, a wireless communicator, an engine, a battery, a first detector, and a controller. The communication terminal is configured to transmit startup information. The wireless communicator, the engine, the battery, the first detector, and the controller are provided in a vehicle. The first detector is configured to detect a remaining charge of the battery. The controller includes one or more controller processors, and one or more controller memories that are coupled to the controller processor. The one or more controller processors are configured to execute processing including starting up the engine and operating the engine over a running time that is set in advance, when the wireless communicator receives the startup information from the communication terminal. The one or more controller processors are configured to execute processing including determining whether a predetermined condition regarding the battery is met based on at least the remaining charge of the battery. The one or more controller processors are configured to execute processing including stopping the engine based on the running time that is set in advance elapsing, when the predetermined condition is met. The one or more controller processors are configured to execute processing including performing an extension of running time of the engine from the running time that is set in advance, when the predetermined condition is not met.

An engine control system according to an embodiment of the disclosure includes a communication terminal, a wireless communicator, an engine, a battery, a first detector, and a circuit. The communication terminal is configured to transmit startup information. The wireless communicator, the engine, the battery, the first detector, and the circuit are provided in a vehicle. The first detector comprises a sensor and is configured to detect a remaining charge of the battery. The circuit is configured to start up the engine and operate the engine over a running time that is set in advance, when the wireless communicator receives the startup information from the communication terminal. The circuit is configured to determine whether a predetermined condition regarding the battery is met based on at least the remaining charge of the battery. The circuit is configured to stop the engine based on the running time that is set in advance elapsing, when the predetermined condition is met. The circuit is configured to perform an extension of running time of the engine from the running time that is set in advance, when the predetermined condition is not met.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram for describing an engine control system according to an embodiment of the disclosure;

FIG. 2 is a diagram for describing an example of a settings screen according to the embodiment of the disclosure;

FIG. 3 is a diagram for describing an example of a target running time map according to the embodiment of the disclosure;

FIG. 4 is a diagram for describing an example of an extension settings screen according to the embodiment of the disclosure;

FIG. 5 is a flowchart for describing an example of communication terminal side processing according to the embodiment of the disclosure;

FIG. 6 is a flowchart for describing an example of vehicle side processing according to the embodiment of the disclosure; and

FIG. 7 is a diagram for describing an example of a predicted average charging current map according to a modification of the disclosure.

### DETAILED DESCRIPTION

When a vehicle has been stored for a long period of time without being driven, there are cases in which remaining charge of the battery installed in the vehicle is low. When the remaining charge of such a battery is low, there is a possibility that the battery will not be sufficiently charged even though the engine is started up remotely and then the engine is run over a period of time that is set in advance, as in JP-A No. 11-62793. In such a case, when the vehicle is stored again for a long period of time without being driven, there is a possibility that the remaining charge in the battery will become depleted, resulting in electric power shortage.

The disclosure suppresses depletion of the remaining charge in the battery of the vehicle.

Hereinafter, an embodiment of the disclosure will be described in detail with reference to the accompanying drawings. Elements and so forth, including specific dimensions, materials, values, shapes, components, positions of the components, and how the components are coupled to each other, which are illustrated in the embodiment, are merely examples to facilitate understanding of the disclosure and, unless otherwise specified, do not limit the disclosure. Elements in the following exemplary embodiment that are not recited in the most general independent claim of the disclosure are optional and may be provided as appropriate. The drawings are schematic and are not intended to be drawn to scale. In this specification and the drawings, elements having substantially the same functions and configurations are denoted by the same reference signs, and redundant description will be omitted. Also, elements that are not directly related to the disclosure are omitted from illustration.

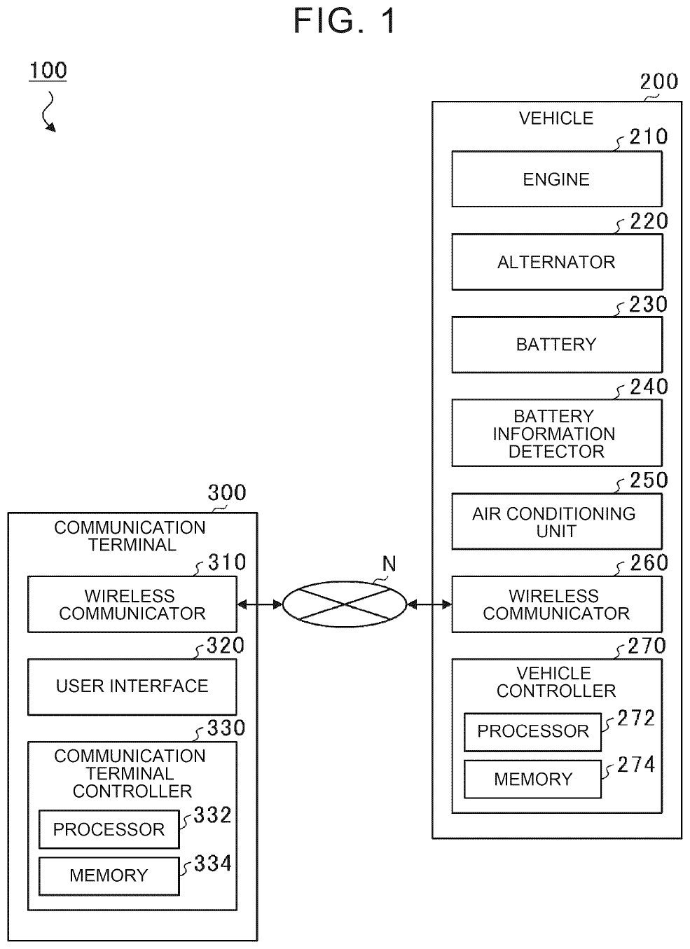

FIG. 1 is a functional block diagram for describing an engine control system 100 according to the embodiment. The engine control system 100 includes a vehicle 200 and a communication terminal 300. The vehicle 200 and the communication terminal 300 are communicably coupled to each other via a communication network N. The communication network N is a wireless communication line network for communicably coupling the vehicle 200 and the communication terminal 300 to each other. The communication network N is made up of various types of networks, such as a satellite communication network for GPS (Global Positioning System), a mobile phone network, the Internet, a LAN (Local Area Network), a WAN (Wide Area Network), other dedicated line networks, and so forth. In order to couple the vehicle 200 and the communication terminal 300 to each other so as to be capable of wireless communication, at least part of the communication network N includes a wireless network. Note, however, that the communication network N may include a wired network as part thereof. Also, the vehicle 200 and the communication terminal 300 may be coupled to each other so as to be able to communicate directly with each other without using the communication network N, by using short-range wireless communication such as Bluetooth.

As illustrated in FIG. 1, the vehicle 200 includes an engine 210, an alternator 220, a battery 230, a battery information detector 240, an air conditioning unit 250, a wireless communicator 260, and a vehicle controller 270.

The engine 210 is a gasoline engine or a diesel engine. The engine 210 obtains driving force by combustion of fuel such as gasoline, diesel fuel, or the like, that is supplied from a fuel tank that is omitted from illustration.

The engine 210 is provided with an injector and a spark plug, which are omitted from illustration. The injector injects fuel to supply the fuel into a combustion chamber that is omitted from illustration. A distal end of the spark plug is disposed within the combustion chamber and ignites an air-fuel mixture of fuel and air that is supplied into the combustion chamber. The air-fuel mixture of fuel and air is ignited by the spark plug at a predetermined timing and thus is combusted. The engine 210 can obtain driving force by this combustion.

The alternator 220 is a small-capacity generator that generates electricity using the driving force of the engine 210. The alternator 220 is coupled to the vehicle controller 270, and driving of the alternator 220 is controlled based on control commands from the vehicle controller 270.

The battery 230 is coupled to the alternator 220, and is charged by electric power that is generated by the alternator 220. Also, the battery 230 is coupled to various types of electrical equipment that are installed in the vehicle 200, and supplies electric power to the various types of electrical equipment. Examples of the electrical equipment include headlights, tail lights, turn indicator lights, vehicle audio, an automotive navigation system, and so forth.

The battery information detector 240 detects various types of information related to the battery 230. In the embodiment, the battery information detector 240 can detect a State of Charge (SOC) and temperature of the battery 230. For example, the battery information detector 240 may detect the SOC of the battery 230 based on a voltage that is detected by a voltage sensor, omitted from illustration, that is capable of detecting voltage of the battery 230. Note that the SOC indicates a percentage of a current charging capacity relative to a full charging capacity, and indicates a charge rate of the battery 230. Also, the battery information detector 240 may detect the temperature of the battery 230 using a temperature sensor, omitted from illustration, that is capable of detecting the temperature of the battery 230. That is to say, the battery information detector 240 may detect the SOC of the battery 230 and detect the temperature of the battery 230, using separate sensors. Note, however, that the battery information detector 240 may detect the SOC of the battery 230 and detect the temperature of the battery 230, using a common sensor. Also, when a temperature of an electrolyte in the battery 230 can be detected, the temperature of the electrolyte may be detected instead of the temperature of the battery 230.

The air conditioning unit 250 is an air conditioning unit that cools or heats inside of a vehicle cabin of the vehicle 200. The air conditioning unit 250 provides a comfortable vehicle cabin environment by continuously maintaining the temperature inside of the vehicle cabin at an appropriate temperature, regardless of changes in the temperature in external space. The air conditioning unit 250 has a compressor that is omitted from illustration, a condenser that is omitted from illustration, an expansion valve that is omitted from illustration, and an evaporator that is omitted from illustration.

The compressor that is omitted from illustration compresses a refrigerant circulating in the air conditioning unit 250. The compressor is coupled to the engine 210 via a clutch that is omitted from illustration. When the clutch is engaged, the driving force of the engine 210 is transmitted to the compressor, and the driving force of the engine 210 operates the compressor to compress the refrigerant. When the clutch is disengaged, the transmission of the driving force between the engine 210 and the compressor is stopped, and the operation of the compressor is stopped.

The condenser (condensation unit) that is omitted from illustration condenses the refrigerant that is compressed by the compressor, and thus performs liquification thereof. The expansion valve expands the refrigerant that has been condensed and liquefied by the condenser. The evaporator evaporates the refrigerant that is expanded by the expansion valve, and while doing so, uses latent heat of evaporation of the refrigerant to cool the air to be blown into the vehicle cabin.

The air conditioning unit 250 is coupled to the vehicle controller 270, and the driving of the compressor is controlled based on a control command from the vehicle controller 270. For example, when the air conditioning unit 250 is in a cooling mode, high-temperature, high-pressure gas-phase refrigerant that is compressed by the compressor is condensed into a liquid by the condenser, and then circulated to the compressor again via the expansion valve and the evaporator. During this process, low-temperature, low-pressure liquid refrigerant that is expanded by the expansion valve is supplied to the evaporator. The air is cooled by heat exchange with the refrigerant that is evaporated in the evaporator, and the cooled air is discharged into the vehicle cabin. This cools inside of the vehicle cabin.

The wireless communicator 260 wirelessly communicates with a later-described wireless communicator 310 of the communication terminal 300, via the communication network N.

The vehicle controller 270 includes one or more processors 272 and one or more memories 274 coupled to the processor 272. The memory 274 includes read-only memory (ROM) in which programs and the like are stored, and random-access memory (RAM) as a work area. The processor 272 of the vehicle controller 270 collaborates with a program that is contained in the memory 274, to serve as the vehicle controller 270 and to control the entire vehicle 200.

For example, when startup information that is transmitted from the communication terminal 300 is received remotely via the wireless communicator 260, the vehicle controller 270 starts up the engine 210 based on the startup information. Also, the vehicle controller 270 controls the driving of the compressor of the air conditioning unit 250 based on the startup information. Furthermore, the vehicle controller 270 controls the driving of the alternator 220 based on the startup information, and charges the battery 230 with electric power that is generated by the driving force of the engine 210.

Examples of the communication terminal 300 include electronic equipment such as a smartphone, a tablet, a personal computer, or the like. The communication terminal 300 may be portable electronic equipment, or may be stationary electronic equipment. Now, a user of the communication terminal 300 is also a user of the vehicle 200, and will hereinafter be referred to as “user” without distinction therebetween.

As illustrated in FIG. 1, the communication terminal 300 includes the wireless communicator 310, the user interface 320, and a communication terminal controller 330.

The wireless communicator 310 wirelessly communicates with the wireless communicator 260 of the vehicle 200, via the communication network N.

The user interface 320 includes, for example, an output device such as a display or the like that presents various types of information to the user, and an input device such as a touch panel or the like that accepts input operations performed by the user.

The communication terminal controller 330 includes one or more processors 332 and one or more memories 334 coupled to the processors 332. The memory 334 includes ROM in which programs and the like are stored, and RAM as a work area. The processor 332 of the communication terminal controller 330 collaborates with a program that is contained in the memory 334, to serve as the communication terminal controller 330 and to control the entire communication terminal 300.

For example, the communication terminal controller 330 can transmit startup information for startup of the engine 210 to the wireless communicator 260 of the vehicle 200, via the wireless communicator 310, in response to an input operation that is performed by the user.

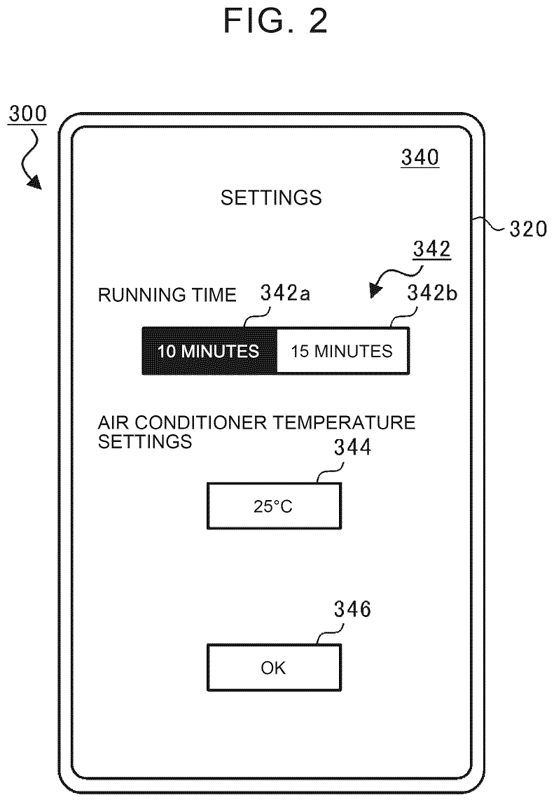

FIG. 2 is a diagram for describing an example of a settings screen 340 according to the embodiment of the disclosure. Before startup of the engine 210 remotely, the user downloads a dedicated application from a server, omitted from illustration, to the communication terminal 300 in advance.

Once the dedicated application is started, the settings screen 340 that is illustrated in FIG. 2 is displayed on the user interface 320. As illustrated in FIG. 2, the settings screen 340 is provided with a plurality of operating portions that can be operated by the user. Here, a running time setting operating portion 342, an air conditioner temperature setting operating portion 344, and an OK operating portion 346 are displayed as operating portions.

The running time setting operating portion 342 includes a first running time setting operating portion 342a and a second running time setting operating portion 342b. The first running time setting operating portion 342a serves as an operating portion for the user to set the running time of the engine 210 to a first amount of time. The second running time setting operating portion 342b serves as an operating portion for the user to set the running time of the engine 210 to a second amount of time that is longer than the first amount of time. FIG. 2 illustrates a case in which the first amount of time is 10 minutes, and the second amount of time is 15 minutes, in the embodiment. Also, the first running time setting operating portion 342a or the second running time setting operating portion 342b that is currently selected by the user is displayed in a highlighted manner. FIG. 2 illustrates a case in which the first running time setting operating portion 342a is selected and the first running time setting operating portion 342a is displayed highlighted.

In the embodiment, a case is illustrated in which the user can select a desired running time from a plurality of running times that is set in advance, such as the first amount of time and the second amount of time. Note, however, that an arrangement may be made in which the running time is not selected by the user, but rather is set to a predetermined running time that is set in advance, such as 10 minutes or the like. Also, the running time may be specified by the user in one-minute increments from a value within a range that is set in advance, for example, between 10 minutes and 30 minutes, or the like. Also, the running time may specifiable based on a value that is input by the user, for example.

Also, the air conditioner temperature setting operating portion 344 serves as an operating portion for specifying the temperature settings of the air conditioning unit 250 of the vehicle 200. In the embodiment, a case is illustrated in which the user can select a desired temperature setting. Also, the temperature setting may be specifiable based on a value that is input by the user, for example. Note that the user may be able to specify that the air conditioning unit 250 is not to be driven.

When the user operates the OK operating portion 346, the communication terminal controller 330 transmits startup information for startup of the engine 210 to the wireless communicator 260 of the vehicle 200, via the wireless communicator 310. The startup information includes initial running time information indicating settings contents of the running time setting operating portion 342 (hereinafter referred to as initial running time). The startup information also includes temperature setting information indicating settings contents of the air conditioner temperature setting operating portion 344. The startup information may also include authentication information for identifying the user.

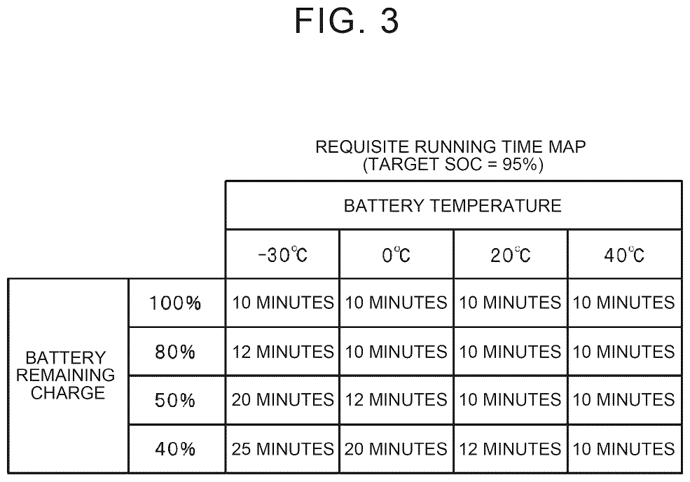

Upon receiving the startup information that is transmitted from the communication terminal 300 via the wireless communicator 260, the vehicle controller 270 of the vehicle 200 may perform predetermined authentication processing based on the authentication information that is included in the startup information. When authentication of the user is successfully completed through the predetermined authentication processing, the vehicle controller 270 executes target running time derivation processing to derive target running time, by referencing a target running time map that is illustrated in FIG. 3, which will be described later.

FIG. 3 is a diagram for describing an example of the target running time map according to the embodiment of the disclosure. The target running time map is stored in the memory 274 of the vehicle 200.

When the vehicle 200 has been stored for a long period of time without being driven, the SOC of the battery 230 of the vehicle 200 may be low. When the SOC of such a battery 230 is low, the battery 230 may not be sufficiently charged even though the engine 210 is operated over the running time that is specified by the user. In such a case, when the vehicle 200 is stored again for a long period of time without being driven, there is a possibility that the remaining charge in the battery 230 will become depleted, resulting in electric power shortage.

As illustrated in FIG. 3, the target running time map defines the target running time for sufficiently charging the battery 230, based on the SOC and temperature of the battery 230.

The time taken to fully charge the battery 230 tends to be longer, the lower the SOC of the battery 230 is. Also, the time taken to fully charge the battery 230 tends to be longer, the lower the temperature of the battery 230 is.

Accordingly, as illustrated in FIG. 3, according to the embodiment, the target running time is set in the target running time map such that the target running time tends to become longer the lower the SOC of the battery 230 is. Also, as illustrated in FIG. 3, in the target running time map, the target running time is set in the target running time map such that the target running time tends to become longer the lower the temperature of the battery 230 is.

The vehicle controller 270 then derives the target running time by referencing the target running time map that is illustrated in FIG. 3, based on the SOC and the temperature of the battery 230. Also, when the initial running time that is specified by the user is equal to or greater than the target running time that is derived, the vehicle controller 270 determines that the initial running time will be sufficient to charge the battery 230. The vehicle controller 270 then starts up the engine 210 and operates the engine 210 over the initial running time. Also, the vehicle controller 270 controls operation of the air conditioning unit 250 based on the temperature setting information that is included in the startup information.

Also, when the initial running time is shorter than the target running time that is derived, the vehicle controller 270 determines that charging of the battery 230 by the initial running time will be insufficient. The vehicle controller 270 then transmits extension request information, for requesting permission from the user to extend the running time of the engine 210 from the initial running time, to the wireless communicator 310 of the communication terminal 300 via the wireless communicator 260. The extension request information includes extension time information indicating the difference between the initial running time and the target running time.

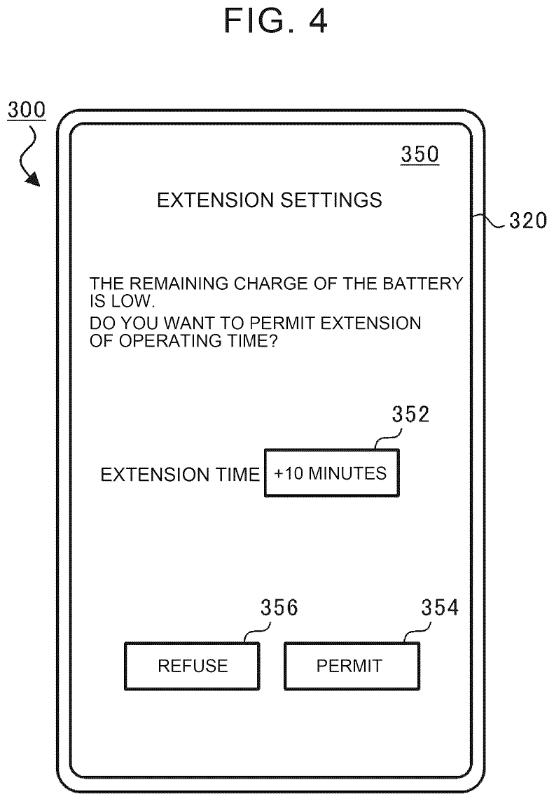

Upon receiving the extension request information that is transmitted from the vehicle 200 via the wireless communicator 310, the communication terminal controller 330 displays an extension settings screen 350 illustrated in FIG. 4, which will be described later, on the user interface 320, based on the extension time information that is included in the extension request information.

FIG. 4 is a diagram for describing an example of the extension settings screen 350 according to the embodiment of the disclosure. As illustrated in FIG. 4, the extension settings screen 350 displays a message to notify the user to the effect that the remaining charge of the battery 230 is low.

The extension settings screen 350 also includes an extension time display 352. The communication terminal controller 330 displays the extension time on the extension time display 352 based on the extension time information that is included in the extension request information. In the case of FIG. 4, 10 minutes is displayed as the extension time.

As illustrated in FIG. 4, the extension settings screen 350 is provided with a plurality of operating portions that can be operated by the user. Here, a permission operating portion 354 for permitting extension of the running time of the engine 210, and a refusal operating portion 356 for refusing extension of the running time of the engine 210, are displayed as operating portions.

When the user operates the refusal operating portion 356, the communication terminal controller 330 transmits extension refusal information to the wireless communicator 260 of the vehicle 200 via the wireless communicator 310, to refuse the extension of the running time of the engine 210.

Then, upon receiving the extension refusal information transmitted from the communication terminal 300 via the wireless communicator 260, the vehicle controller 270 of the vehicle 200 starts up the engine 210 and operates the engine 210 over the initial running time. Also, the vehicle controller 270 controls the operation of the air conditioning unit 250 based on the temperature setting information that is included in the startup information.

Also, when the user operates the permission operating portion 354, the communication terminal controller 330 transmits extension permission information to the wireless communicator 260 of the vehicle 200 via the wireless communicator 310, to permit extension of the running time of the engine 210.

Then, upon receiving the extension permission information that is transmitted from the communication terminal 300 via the wireless communicator 260, the vehicle controller 270 of the vehicle 200 performs startup of the engine 210 and operates the engine 210 over the target running time that is derived. Also, the vehicle controller 270 controls the operation of the air conditioning unit 250 based on the temperature setting information that is included in the startup information.

Also, the vehicle controller 270 of the vehicle 200 executes predetermined ending processing when the running time of the engine 210 has elapsed. In the predetermined ending processing, the vehicle controller 270 of the vehicle 200 ends the operation of the engine 210 and ends the operation of the air conditioning unit 250.

Such an engine control system 100 according to the embodiment enables extending the running time in accordance with the state of the battery 230 of the vehicle 200. Accordingly, the remaining charge of the battery 230 of the vehicle 200 can be suppressed from being depleted. Also, an appropriate target running time can be derived, based on the SOC and the temperature of the battery 230. Thus, the extension time can be suppressed from becoming unnecessarily long.

Also, whether to extend the running time of the engine 210 is ultimately determined based on operations that are performed by the user. Thus, a situation in which the running time of the engine 210 is extended without permission, against the intent of the user, can be circumvented, and the user can be kept from feeling distrustful. Processing that is executed in the vehicle controller 270 of the vehicle 200, and processing that is executed in the communication terminal controller 330 of the communication terminal 300, will be described below.

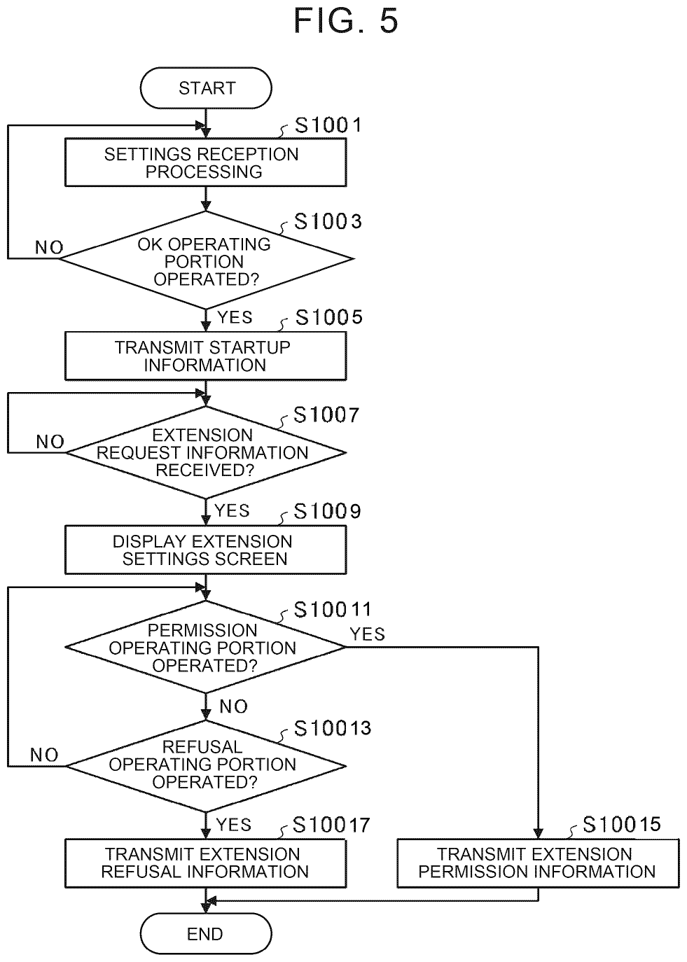

FIG. 5 is a flowchart for describing an example of communication terminal 300 side processing according to the embodiment of the disclosure. Various types of processing that are executed in the communication terminal 300 side processing can be executed by the processor 332 of the communication terminal controller 330 of the communication terminal 300. In detail, various types of processing are performed by the processor 332 executing a program that is stored in the memory 334 of the communication terminal controller 330 of the communication terminal 300.

When the dedicated application is started in the communication terminal 300, the communication terminal controller 330 causes the user interface 320 to display the settings screen 340 illustrated in FIG. 2, as illustrated in FIG. 5. That is to say, the communication terminal controller 330 executes settings reception processing for receiving various types of operations performed by the user (S1001). Note that in the settings reception processing, the communication terminal controller 330 executes switching of the display contents of the running time setting operating portion 342 and the air conditioner temperature setting operating portion 344, based on operations performed by the user.

The communication terminal controller 330 determines whether the OK operating portion 346 of the settings screen 340 has been operated by the user (S1003). When the OK operating portion 346 has not been operated (NO in S1003), the communication terminal controller 330 stands by until the OK operating portion 346 is operated.

Also, when the OK operating portion 346 has been operated (YES in S1003), the communication terminal controller 330 transmits startup information for startup of the engine 210 to the wireless communicator 260 of the vehicle 200, via the wireless communicator 310 (S1005). As described above, the startup information includes running time information indicating the settings contents of the running time setting operating portion 342 and set temperature information indicating the settings contents of the air conditioner temperature setting operating portion 344.

Also, the communication terminal controller 330 determines whether extension request information that is transmitted from the vehicle 200 has been received via the wireless communicator 310 (S1007). When no extension request information has been received (NO in S1007), the communication terminal controller 330 stands by for reception of the extension request information over a predetermined standby time. When no extension request information has been received when the predetermined standby time has elapsed, the communication terminal-side processing ends. Note that the predetermined standby time may be, for example, around 10 seconds.

Also, when the extension request information is received (YES in S1007), the communication terminal controller 330 displays the extension settings screen 350 that is illustrated in FIG. 4 on the user interface 320 (S1009).

The communication terminal controller 330 determines whether the permission operating portion 354 of the extension settings screen 350 has been operated by the user (S10011). Also, when the permission operating portion 354 has not been operated (NO in S10011), the communication terminal controller 330 determines whether the refusal operating portion 356 of the extension settings screen 350 has been operated by the user (S10013). When the refusal operating portion 356 has not been operated (NO in S10013), the communication terminal controller 330 stands by until the permission operating portion 354 or the refusal operating portion 356 is operated.

Also, when the permission operating portion 354 has been operated (YES in S10011), the communication terminal controller 330 transmits extension permission information to permit the extension of the running time of the engine 210 to the wireless communicator 260 of the vehicle 200 via the wireless communicator 310 (S10015), and ends the communication terminal side processing.

Also, when the refusal operating portion 356 has been operated (YES in S10013), the communication terminal controller 330 transmits extension refusal information to refuse the extension of the running time of the engine 210 to the wireless communicator 260 of the vehicle 200 via the wireless communicator 310 (S10017), and ends the communication terminal side processing.

Note that when neither the permission operating portion 354 nor the refusal operating portion 356 has been operated when a predetermined standby time that is set in advance has elapsed, the communication terminal controller 330 may transition to the processing of step S10015 above based on the elapse of the predetermined standby time, and transmit the extension permission information. Alternatively, the communication terminal controller 330 may transition to the processing of step S10017 above, based on the passage of the predetermined standby time, and transmit the extension refusal information. Note that the predetermined standby time may be, for example, around 10 seconds.

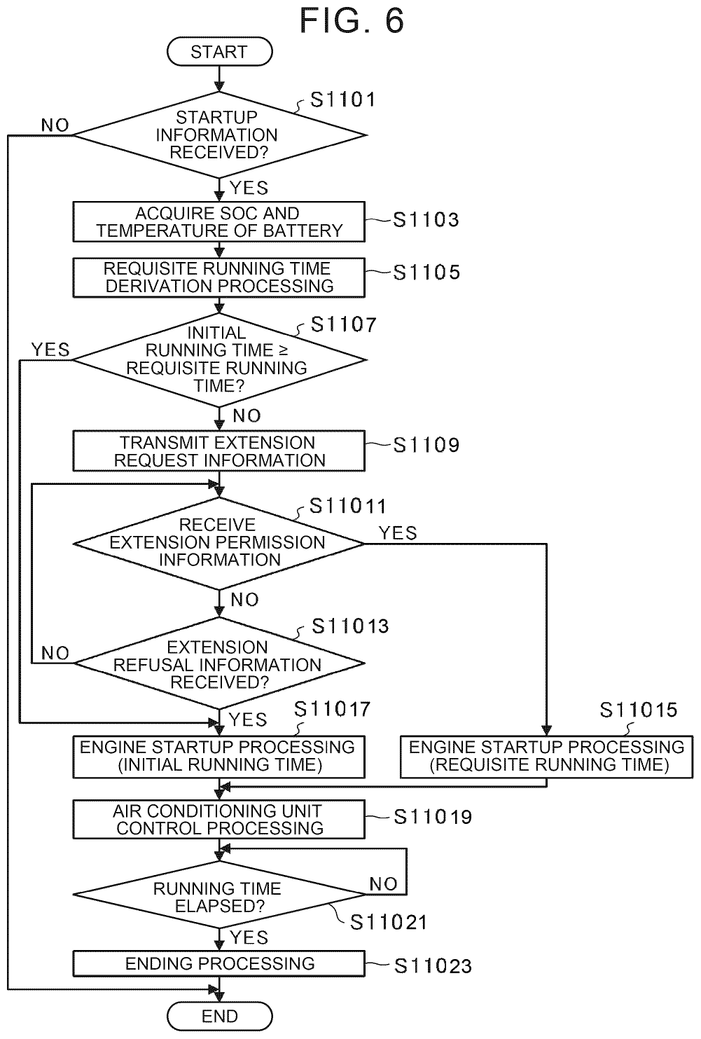

FIG. 6 is a flowchart for describing an example of vehicle side processing according to the embodiment of the disclosure. Various types of processing that are executed in the vehicle side processing can be executed by the processor 272 of the vehicle controller 270 of the vehicle 200. In detail, various types of processing are performed by the processor 272 executing a program that is stored in the memory 274 of the vehicle controller 270 of the vehicle 200. Note that the vehicle side processing illustrated in FIG. 6 is executed repeatedly.

As illustrated in FIG. 6, the vehicle controller 270 determines whether the startup information that is transmitted from the communication terminal 300 has been received via the wireless communicator 260 (S1101). When the startup information has been received (YES in S1101), the vehicle controller 270 acquires the SOC and the temperature of the battery 230 that are detected by the battery information detector 240 (S1103).

Also, the vehicle controller 270 executes the target running time derivation processing to derive the target running time, by referencing the target running time map that is illustrated in FIG. 3, based on the SOC and the temperature of the battery 230 that are acquired in step S1103 above (S1105).

Also, the vehicle controller 270 determines whether the initial running time that is identified by the startup information that is received in step S1101 above is equal to or longer than the target running time that is derived in step S1105 above (S1107).

As a result, when the initial running time is equal to or longer than the target running time (YES in S1107), the vehicle controller 270 transitions the processing to step S11017, which will be described later. Also, when the initial running time is not equal to or longer than the target running time (NO in S1107), the vehicle controller 270 transmits extension request information to the wireless communicator 310 of the communication terminal 300 via the wireless communicator 260 to request permission of the user to extend the running time of the engine 210 from the initial running time (S1109).

The vehicle controller 270 then determines whether the extension permission information that is transmitted from the communication terminal 300 has been received via the wireless communicator 260 (S11011). Also, when no extension permission information has been received (NO in S11011), the vehicle controller 270 determines whether the extension refusal information that is transmitted from the communication terminal 300 has been received via the wireless communicator 260 (S11013). When no extension refusal information has been received (NO in S11013), the vehicle controller 270 stands by until either the extension permission information or the extension refusal information is received.

When the extension permission information has been received (YES in S11011), the vehicle controller 270 executes engine startup processing to start up the engine 210 and operate the engine 210 over the target running time that is derived in step S1105 above (S11015). Also, in the engine startup processing (S11015), the vehicle controller 270 sets the target running time as the running time.

Also, when the initial running time is longer than the target running time (YES in S1107), and when the extension refusal information is received (YES in S11013), the vehicle controller 270 executes engine startup processing to start up the engine 210 and operate the engine 210 over the initial running time (S11017). Also, in the engine startup processing (S11017), the vehicle controller 270 sets the initial running time as the running time.

Also, the vehicle controller 270 executes air conditioning unit control processing for controlling the operation of the air conditioning unit 250 based on the temperature setting information that is included in the startup information (S11019).

Also, the vehicle controller 270 determines whether the running time that is set in step S11015 above or step S11017 above has elapsed. As a result, when the set running time has not elapsed (NO in S11021), the vehicle controller 270 stands by until the running time has elapsed. Also, when the running time that is set has elapsed (YES in S11021), the vehicle controller 270 executes predetermined ending processing (S11023). In the ending processing (S11023), the vehicle controller 270 of the vehicle 200 ends the operation of the engine 210 and ends the operation of the air conditioning unit 250.

As described above, the engine control system 100 according to the embodiment includes the communication terminal 300, the wireless communicator 260, the engine 210, the battery 230, a first detector (the battery information detector 240, as one embodiment), and a controller (the vehicle controller 270, as one embodiment). The communication terminal 300 is configured to transmit the startup information. The wireless communicator 260, the engine 210, the battery 230, the first detector, and the controller are provided in the vehicle 200. The first detector is configured to detect the remaining charge of the battery 230. The controller includes one or more controller processors (the processor 272, as one embodiment) and one or more controller memories (the memory 274, as one embodiment) that are coupled to the one or more controller processors. The one or more controller processors are configured to execute processing including starting up the engine 210 and operating the engine 210 over a running time that is set in advance, when the wireless communicator 260 receives startup information from the communication terminal 300 (in the above embodiment, steps S1101 to S11023, as one example). The one or more controller processors are also configured to execute processing including determining whether a predetermined condition regarding the battery 230 is satisfied based on at least the remaining charge of the battery 230 (step S1107 in the above embodiment, as one example). Also, the one or more controller processors are configured to, when the predetermined condition is met (in the above embodiment, YES in step S1107, as one example), execute processing including stopping the engine 210 based on the running time that is set in advance elapsing (in the above embodiment, steps S11017, S11021, and S11023, as one example). Also, the one or more controller processors are configured to execute processing including performing an extension of running time of the engine 210 from the running time that is set in advance (in the above embodiment, steps S11015, S11021, and S11023, as one example) when the predetermined condition is not met (in the above embodiment, NO in step S1107, as one example).

Such an engine control system 100 according to the embodiment enables the extension of the running time of the engine 210 in accordance with the state of the battery 230 of the vehicle 200. Accordingly, the remaining charge of the battery 230 of the vehicle 200 can be suppressed from being depleted.

Also, the engine control system 100 may include a second detector (the battery information detector 240, as one embodiment) that is provided in the vehicle 200 and is capable of detecting the temperature of the battery 230. The one or more controller processors may also be configured to execute processing (in the above embodiment, step S1105, as one example) that includes determining a duration of the extension based on at least the remaining charge (SOC) of the battery 230 and the temperature of the battery 230.

Thus, an appropriate extension time can be set based on the SOC and the temperature of the battery 230, and hence the extension time can be suppressed from becoming unnecessarily long.

The communication terminal 300 may also include one or more communication terminal processors (the processor 332, as one embodiment) and one or more communication terminal memories (the memory 334, as one embodiment) coupled to the one or more communication terminal processors. Also, the one or more controller processors may be configured to execute processing (in the above embodiment, step S1109, as one example) that includes transmitting extension request information requesting the extension to the communication terminal 300 via the wireless communicator 260, when the predetermined condition is not met (in the above embodiment, NO in step S1107, as one example). The one ore more communication terminal processors may be configured to execute processing including transmitting extension permission information to the wireless communicator 260 (in the above embodiment, step S10015, as one example) when the extension request information is received (in the above embodiment, YES in step S1007, as one example) and when a predetermined operation that is performed by the user is accepted (in the above embodiment, YES in step S10011, as one example). Also, the one or more controller processors may be configured to execute processing including the extension (in the above embodiment, step S11015, as one example) when the predetermined condition is not met (in the above embodiment, NO in step S1107, as one example) and when the extension permission information is received (in the above embodiment, YES in step S11011, as one example).

Thus, whether to perform the extension of the running time of the engine 210 is ultimately determined based on operations that are performed by the user. Accordingly, a situation in which the running time of the engine 210 is extended without permission, against the intent of the user, can be circumvented, and the user can be kept from feeling distrustful.

### Modification

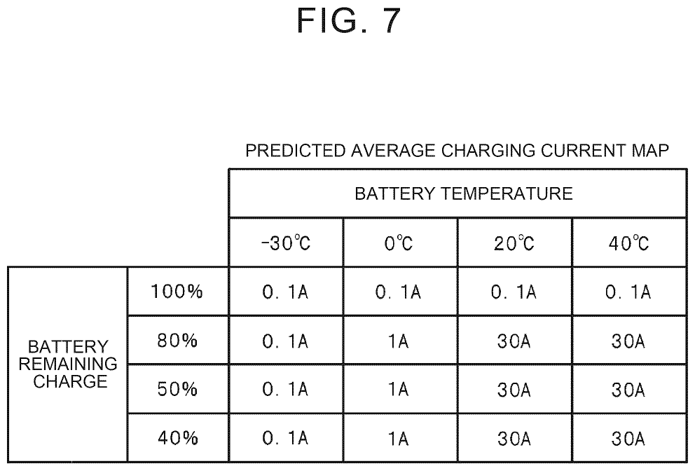

In the above embodiment, the case in which the target running time is derived based on the target running time map illustrated in FIG. 3 in step S1105 is described. However, the method of deriving the target running time is not limited to this. Processing that is executed instead of step S1105 in the above embodiment will be described below. FIG. 7 is a diagram for describing an example of a predicted average charging current map according to a modification of the disclosure. In the modification, the predicted average charging current map is stored in the memory 274 of the vehicle 200.

As illustrated in FIG. 7, the predicted average charging current map defines a predicted value of the electric current value when the battery 230 is charged (hereinafter referred to as predicted average charging current) based on the SOC and the temperature of the battery 230.

The value of the current that is applied to the battery 230 when the battery 230 is charged tends to be higher the lower the SOC of the battery 230 is. Also, the value of the current that is applied to the battery 230 when the battery 230 is charged tends to be higher the higher the temperature of the battery 230 is.

As illustrated in FIG. 7, according to the modification, in the predicted average charging current map, the value of the predicted average charging current is set such that the lower the SOC of the battery 230 is, the higher the value of the predicted average charging current tends to be. Also, as illustrated in FIG. 7, in the predicted average charging current map, the value of the predicted average charging current is set such that the higher the temperature of the battery 230 is, the higher the value of the predicted average charging current tends to be.

The vehicle controller 270 then derives a predicted average charging current by referencing the predicted average charging current map that is illustrated in FIG. 7, based on the SOC and the temperature of the battery 230. Also, the vehicle controller 270 derives a target charging capacity based on a difference between a target SOC value of the battery 230 and the current SOC of the battery 230. Also, the vehicle controller 270 derives the target running time by dividing the target charging capacity that is derived by the predicted average charging current.

Thus, an appropriate target running time can be derived based on the SOC and the temperature of the battery 230. Accordingly, the extended time can be suppressed from becoming unnecessarily long, and fuel mileage can be suppressed from deteriorating.

Although the embodiment and modification of the disclosure have been described above with reference to the accompanying drawings, the disclosure is not limited to such embodiment and modification. Those skilled in the art will be capable of conceiving various changes and modifications within the scope of the claims. It is understood that the scope of the disclosure also encompasses the scope that a person skilled in the art could conceive.

Note that the series of processing performed by the vehicle 200 and the communication terminal 300 according to the above embodiment may be realized using any of software, hardware, or a combination of software and hardware. A program constituting the software is stored in advance, for example, in a non-transitory storage medium that is provided inside or outside of each device. The program is then read from the non-transitory storage medium (e.g., ROM) to a temporary storage medium (e.g., RAM), and executed by a processor such as a CPU or the like, for example.

Also, according to the above embodiment, a program for executing the processing of each function of the vehicle 200 and the communication terminal 300 can be provided. Further, a non-transitory computer-readable recording medium having the program stored therein can also be provided. The non-transitory recording medium may be, for example, a disk-type recording medium such as an optical disc, a magnetic disk, a magneto-optical disc, or the like, or may be a semiconductor memory such as flash memory, USB memory, or the like.

Each of the vehicle controller 270 and the communication terminal controller 330 may be implemented by a circuit including at least one semiconductor integrated circuit, such as at least one application specific integrated circuit (ASIC) and/or at least one field programmable gate array (FPGA), or the like. The ASIC is an integrated circuit (IC) that is customized to execute all or part of the functions of the vehicle controller 270 and the communication terminal controller 330. The FPGA is an integrated circuit that is designed to be configured after manufacturing to execute all or part of the functions of the vehicle controller 270 and the communication terminal controller 330.

What is claimed is:

1. An engine control system comprising:
a communication terminal that is configured to transmit startup information;
a wireless communicator that is provided in a vehicle;
an engine that is provided in the vehicle;
a battery that is provided in the vehicle;
a first detector that is provided in the vehicle and that is configured to detect a remaining charge of the battery; and
a controller that is provided in the vehicle; wherein
the controller comprises
one or more controller processors, and
one or more controller memories that are coupled to the one or more controller processors, and
the one or more controller processors are configured to execute processing comprising
starting up the engine and operating the engine over a running time that is set in advance, when the wireless communicator receives the startup information from the communication terminal,
determining whether a predetermined condition regarding the battery is met based on at least the remaining charge of the battery,
stopping the engine based on the running time that is set in advance elapsing, when the predetermined condition is met, and
performing an extension of running time of the engine from the running time that is set in advance, when the predetermined condition is not met.

2. The engine control system according to claim 1, further comprising a second detector that is provided in the vehicle and that is configured to detect a temperature of the battery, wherein the one or more controller processors are further configured to execute processing comprising determining a duration of the extension, based on at least the remaining charge of the battery and the temperature of the battery.

3. The engine control system according to claim 1, wherein:
the communication terminal comprises
one or more communication terminal processors, and
one or more communication terminal memories that are coupled to the one or more communication terminal processors,
the one or more controller processors are further configured to execute processing comprising transmitting extension request information that requests the extension, to the communication terminal via the wireless communicator, when the predetermined condition is not met;
the one or more communication terminal processors are configured to execute processing comprising transmitting extension permission information to the wireless communicator when the extension request information is received and a predetermined operation that is performed by a user is accepted; and
the one or more controller processors are further configured to execute processing comprising the extension when the predetermined condition is not met and also the extension permission information is received.

4. The engine control system according to claim 2, wherein:
the communication terminal comprises
one or more communication terminal processors, and
one or more communication terminal memories that are coupled to the one or more communication terminal processors,
the one or more controller processors are further configured to execute processing comprising transmitting extension request information that requests the extension, to the communication terminal via the wireless communicator, when the predetermined condition is not met;
the one or more communication terminal processors are configured to execute processing comprising transmitting extension permission information to the wireless communicator when the extension request information is received and a predetermined operation that is performed by a user is accepted; and
the one or more controller processors are further configured to execute processing comprising the extension when the predetermined condition is not met and also the extension permission information is received.

5. An engine control system comprising:
a communication terminal that is configured to transmit startup information;
a wireless communicator that is provided in a vehicle;
an engine that is provided in the vehicle;
a battery that is provided in the vehicle;
a first detector that comprises a sensor and is provided in the vehicle and that is configured to detect a remaining charge of the battery; and
a circuit that is provided in the vehicle, wherein the circuit is configured to
start up the engine and operate the engine over a running time that is set in advance, when the wireless communicator receives the startup information from the communication terminal,
determine whether a predetermined condition regarding the battery is met based on at least the remaining charge of the battery,
stop the engine based on the running time that is set in advance elapsing, when the predetermined condition is met, and
perform an extension of running time of the engine from the running time that is set in advance, when the predetermined condition is not met.
